(19) United States
(12) Patent Application Publication
(10) Pub. No.: US 2021/0181393 A1
(43) Pub. Date: Jun. 17, 2021

(54) OPTICAL FILM, OPTICAL LENS, AND LENS MODULE

(71) Applicant: HON HAI PRECISION INDUSTRY CO., LTD., New Taipei (TW)

(72) Inventors: SHUN-YI YU, New Taipei (TW); WEI-CHENG LING, New Taipei (TW); KENG-PEI CHANG, New Taipei (TW); YONG-JUN WEI, Jincheng (CN)

(21) Appl. No.: 16/935,532

(22) Filed: Jul. 22, 2020

(30) Foreign Application Priority Data
Dec. 14, 2019 (CN) 201911286719.5

(51) Int. Cl. G02B 5/22; G02B 3/00

(52) U.S. Cl. CPC G02B 5/22; G02B 3/0006

(57) ABSTRACT

An optical film includes at least one light-absorbing film layer and at least one anti-reflection film layer formed on the at least one light-absorbing film layer. A material of the at least one light-absorbing film layer is a mixed powder of chromium metal and SiₓO_{y}. The x and the y are respectively greater than 0 and positive integers. The disclosure further relates to an optical lens and a lens module. The optical film can reduce the effect of stray light on the imaging quality.

### FIELD

The subject matter of the application generally relates to an optical film, an optical lens, and a lens module.

### BACKGROUND

A plurality of optical lenses is mounted in an optical lens. Light beams entering into the optical lens can easily be reflected or refracted by the edges of the lenses of the optical lenses, thereby forming stray light. The stray light can affect the imaging quality of the optical lens.

A manufacturer may attempt to reduce the effect of stray light on the imaging quality of the optical lenses by providing shading elements or blackening the edges of the optical lenses. However, the assembly accuracy of the optical lens provided with shading elements is not easy to maintain, which will affect the imaging quality of the optical lens. Blackening the edges of the optical lenses is generally not effective in eliminating the effects of stray light.

Therefore, there is room for improvement in the art.

### BRIEF DESCRIPTION OF THE DRAWINGS

Implementations of the present disclosure will now be described, by way of embodiments, with reference to the attached figures.

FIG. 1 is a perspective view of an embodiment of an optical lens according to the present disclosure.

FIG. 2 is a cross-sectional view along a line II-II of FIG. 1.

FIG. 3 is a cross-sectional view of an anti-reflection film layer of FIG. 2.

FIG. 4 is a transmission spectrogram of optical films of the optical lens of various thicknesses shown in FIG. 1.

FIG. 5 is a reflectance spectrogram of the optical lens of FIG. 1 with an optical film on one surface of the optical lens.

FIG. 6 is a reflectance spectrogram of the optical lens of FIG. 1 with an optical film on one surface of the optical lens.

FIG. 7 is a reflectance spectrogram of the optical lens of FIG. 1 with an optical film on one surface of the optical lens.

FIG. 8 is a perspective view of a lens module including the optical lens of FIG. 1.

FIG. 9 is a perspective view of an electronic device including the lens module of FIG. 8.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain portions may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like.

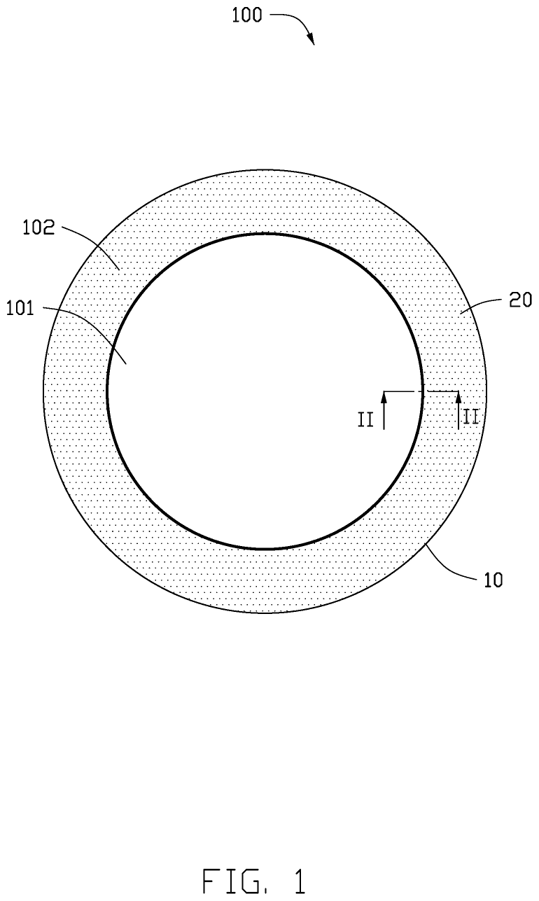

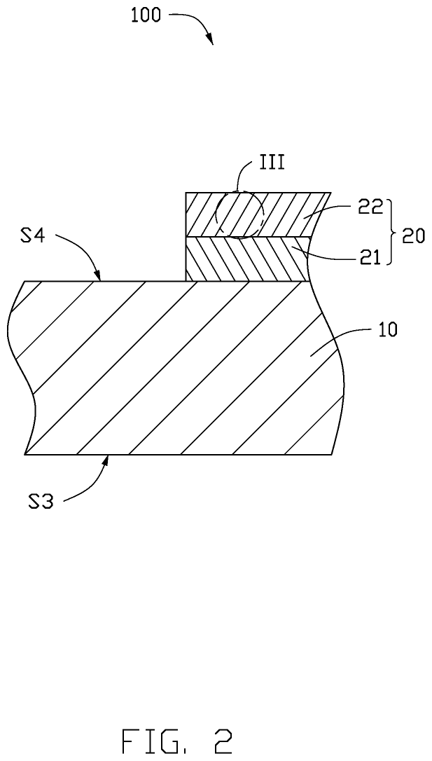

FIGS. 1-2 show an embodiment of an optical lens 100. The optical lens 100 includes a lens 10 and at least one optical film 20 formed on at least one surface of the lens 10.

The lens 10 has refractive power. The lens 10 is a spherical lens or an aspherical lens. The lens 10 includes a central area 101 and a peripheral area 102 surrounding the central area 101 (the boundary between the central area 101 and the peripheral area 102 is indicated by a thick solid line in FIG. 1). The central area 101 is defined as an optical effective diameter area, which is suitable for passing light, and the diameter of the central area 101 is the clear aperture of the lens 10.

The lens 10 includes a first surface S3 and a second surface S4 opposite to the first surface S3. In at least one embodiment, the optical film 20 is formed on the second surface S4. In other embodiments, the optical film 20 may be formed on the first surface S3.

The optical film 20 includes at least one light-absorbing film layer 21 and at least one anti-reflection film layer 22 formed on the at least one light-absorbing film layer 21.

The at least one light-absorbing film layer 21 and the at least one anti-reflection film layer 22 are both formed by a sputtering process.

A material of the at least one light-absorbing film layer 21 is powders of chromium metal and SiₓO_{y} mixed together, wherein x and y are both greater than 0 and positive integers. In at least one embodiment, the SiₓO_{y} is SiO₂.

In the at least one light-absorbing film layer 21, a range of the atomic weight content percentage of the chromium powder is from 0% to 30%.

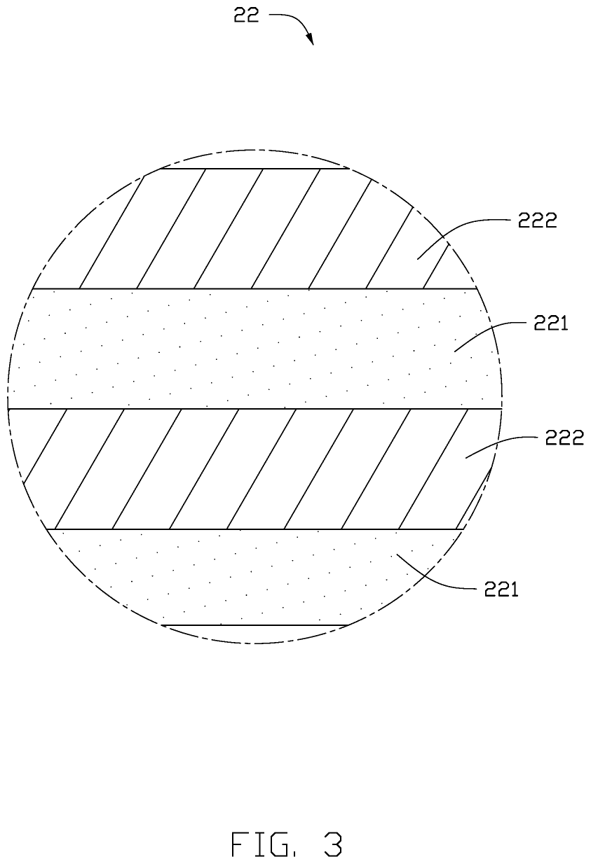

Referring to FIG. 3, the anti-reflection film layer 22 includes at least one first film layer 221. A material of the first film layer 221 is one of SiₓO_{y} or TiₘOₙ, m and n are both greater than 0 and positive integers. In at least one embodiment, the SiₓO_{y} is SiO₂, and the TiₘOₙ is Ti₃O₅.

The at least one anti-reflection film layer 22 further includes at least one second film layer 222. The second film layer 222 and the first film layer 221 alternate together. A material of the second film layer 222 is one of SiₓO_{y} or TiₘOₙ. A material of the second film layer 222 is different from a material of the first film layer 221.

Referring to FIG. 3, in this embodiment, the at least one anti-reflection film layer 22 includes two first film layers 221 and two second film layers 222. The two first film layers 221 and the two second film layers 222 alternate together. In this embodiment, a material of the first film layer 221 is SiO₂, and a material of the second film layer 222 is Ti₃O₅.

A thickness of the at least one light-absorbing film layer 21 is defined as H₁, 450 nm≤H₁≤550 nm. A thickness of the at least one anti-reflection film layer 22 is defined as H₂, 50 nm≤H₂≤100 nm, or 300 nm≤H₂≤400 nm.

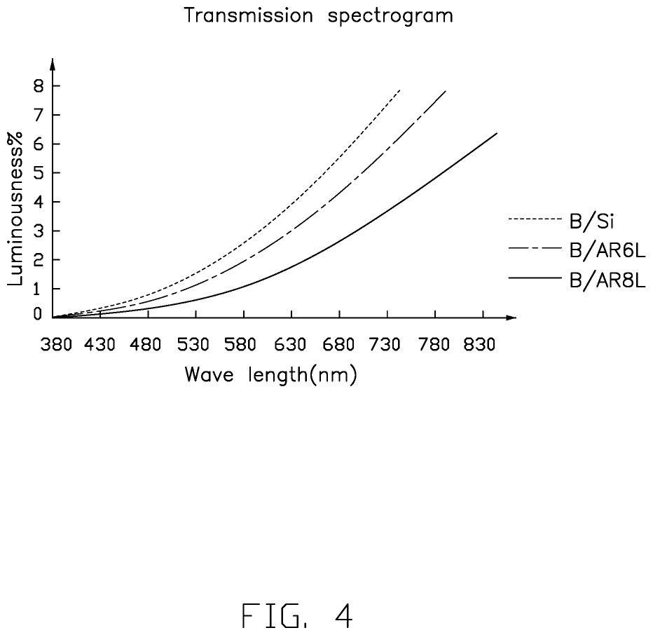

FIG. 4 is a transmission spectrogram of the optical films of the optical lens of various thicknesses shown in FIG. 1. B/Si means that a material of the at least one anti-reflection film layer 22 formed on the at least one light-absorbing film layer 21 is SiO₂, and a thickness of the at least one anti-reflection film layer 22 is 70 nm. B/AR6L means that a material of the at least one anti-reflection film layer 22 formed on the at least one light-absorbing film layer 21 is SiO₂/Ti₃O₅, and a thickness of the at least one anti-reflection film layer 22 is 360 nm. B/AR8L means that a material of the at least one anti-reflection film layer 22 formed on the at least one light-absorbing film layer 21 is SiO₂/Ti₃O₅, and a thickness of the at least one anti-reflection film layer 22 is 340 nm.

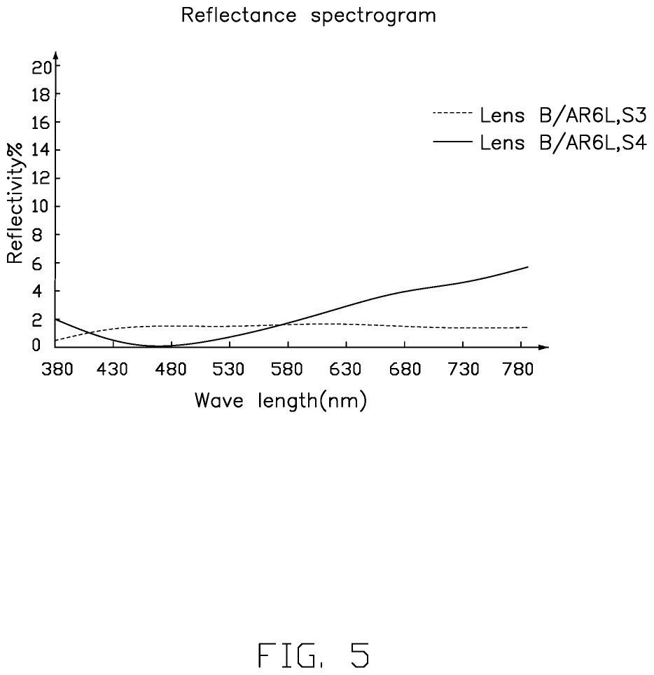

FIG. 5 is a reflectance spectrogram of the optical lens 100 with an optical film 20 on one surface of the optical lens 100. A thickness of the light-absorbing film layer is 525 nm, a thickness of the anti-reflection film layer is 70 nm, and a material of the anti-reflection film layer is SiO₂.

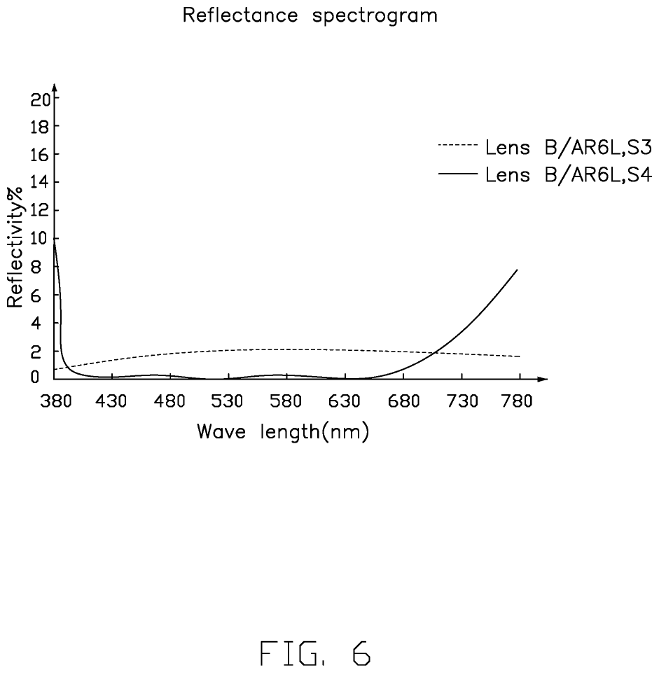

FIG. 6 is a reflectance spectrogram of the optical lens 100 with an optical film 20 on one surface of the optical lens 100. A thickness of the at least one light-absorbing film layer 21 is 525 nm, a thickness of the at least one anti-reflection film layer 22 is 360 nm, and a material of the at least one anti-reflection film layer 22 is SiO₂.

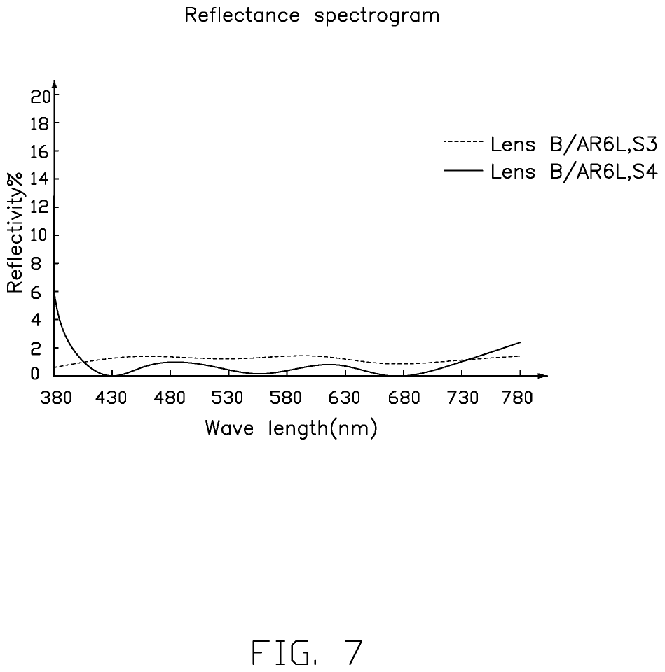

FIG. 7 is a reflectance spectrogram of the optical lens 100 with an optical film 20 on one surface of the optical lens 100. A thickness of the at least one light-absorbing film layer 21 is 525 nm, a thickness of the at least one anti-reflection film layer 22 is 340 nm, and a material of the at least one anti-reflection film layer 22 is SiO₂.

Referring to FIGS. 4 to 5, when H₁=525 nm and H₂=70 nm, the luminousness of the optical film 20 is less than 7% and the reflectivity of the optical film 20 is less than or equal to 5% in a visible light wavelength range of 400 nm to 700 nm.

Referring to FIGS. 4 and 6, when H₁=525 nm and H₂=360 nm, the luminousness of the optical film 20 is less than 5% and the reflectivity of the optical film 20 is less than or equal to 2% in a visible light wavelength range of 400 nm to 700 nm.

Referring to FIGS. 4 and 7, when H₁=525 nm and H₂=340 nm, the luminousness of the optical film 20 is less than 4% and the reflectivity of the optical film 20 is less than or equal to 1.7% in a visible light wavelength range of 400 nm to 700 nm.

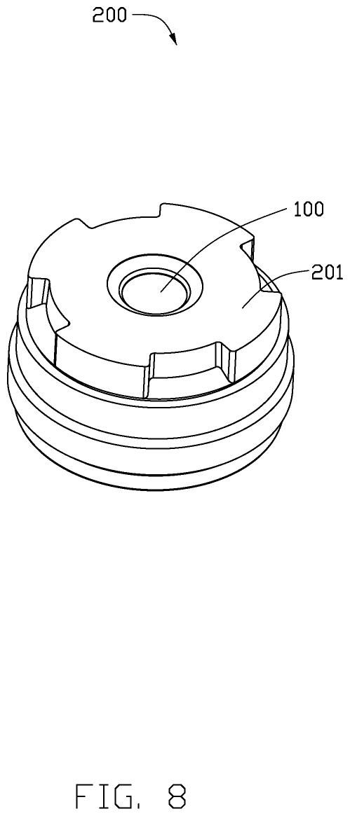

FIG. 8 shows an embodiment of a lens module 200. The lens module 200 includes a shot 201, the shot 201 includes at least one optical lens 100.

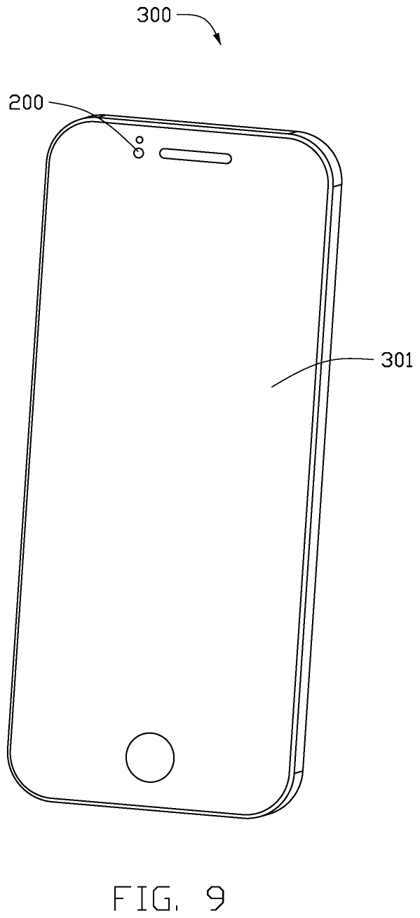

FIG. 9 shows an embodiment of an electronic device 300. The electronic device 300 includes a body 301 and the lens module 200 mounted in the body 301. The electronic device 300 may be a smart phone, a tablet computer, or the like. In at least one embodiment, the electronic device 300 is a smart phone.

With the embodiments described above, the optical film 20 includes the at least one light-absorbing film layer 21 and the at least one anti-reflection film layer 22. A material of the at least one light-absorbing film layer 21 is powders of chromium metal and SiₓO_{y} mixed together. Both the chromium metal and the SiₓO_{y} have a high extinction coefficient, which can increase the absorbance of the optical film 20. Furthermore, a thickness of the anti-reflection film layer 22 of the optical film 20 can be controlled, so that the reflectivity of the optical film 20 can be reduced to below 1.7%, thus stray light and its effect on the imaging quality can be further reduced.

The embodiments shown and described above are only examples. Many details are often found in the art such as the other features of an optical film, an optical lens, a lens module, and an electronic device. Therefore, many such details are neither shown nor described. Even though numerous characteristics and advantages of the present disclosure have been positioned forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims. It will therefore be appreciated that the embodiments described above can be modified within the scope of the claims.

What is claimed is:

1. An optical film comprising:
at least one light-absorbing film layer, and
at least one anti-reflection film layer formed on the at least one light-absorbing film layer; wherein a material of the at least one light-absorbing film layer is powders of chromium metal and SiₓO_{y} mixed together, wherein the x and the y are both greater than 0 and positive integers.

2. The optical film of claim 1, wherein in the at least one light-absorbing film layer, a range of an atomic weight content percentage of the chromium metal powder is from 0% to 30%.

3. The optical film of claim 1, wherein the at least one anti-reflection film layer comprises at least one first film layer, and a material of the at least one first film layer is one of SiₓO_{y} or TiₘOₙ, wherein the m and the n are both greater than 0 and positive integers.

4. The optical film of claim 3, wherein the at least one anti-reflection film layer further comprises at least one second film layer, the at least one second film layer and the at least one first film layer alternate together, a material of the at least one second film layer is one of SiₓO_{y} or TiₘOₙ, a material of the at least one second film layer is different from a material of the at least one first film layer.

5. The optical film of claim 1, wherein a thickness of the at least one light-absorbing film layer is defined as H₁, 450 nm≤H₁≤550 nm; and a thickness of the at least one anti-reflection film layer is defined as H₂, 50 nm≤H₂≤100 nm, or 300 nm≤H₂≤400 nm.

6. The optical film of claim 5, wherein when H₁=525 nm and H₂=70 nm, the luminousness of the optical film is less than 7% and the reflectivity of the optical film is less than or equal to 5% in a visible light wavelength range of 400 nm to 700 nm.

7. The optical film of claim 5, wherein when H₁=525 nm and H₂=360 nm, the luminousness of the optical film is less than 5% and the reflectivity of the optical film is less than or equal to 2% in a visible light wavelength range of 400 nm to 700 nm.

8. The optical film of claim 5, wherein when H₁=525 nm and H₂=340 nm, the luminousness of the optical film is less than 4% and the reflectivity of the optical film is less than or equal to 1.7% in a visible light wavelength range of 400 nm to 700 nm.

9. An optical lens, comprising:
a lens, wherein the lens comprises a central area and a peripheral area surrounding the central area; and
an optical film formed on at least one surface of the lens, wherein the optical film comprises:
at least one light-absorbing film layer, and
at least one anti-reflection film layer formed on the at least one light-absorbing film layer; a material of the at least one light-absorbing film layer is powders of chromium metal and SiₓO_{y} mixed together, the x and the y are both greater than 0 and positive integers.

10. The optical lens of claim 9, wherein in the at least one light-absorbing film layer, a range of an atomic weight content percentage of the chromium metal powder is from 0% to 30%.

11. The optical lens of claim 9, wherein the at least one anti-reflection film layer comprises at least one first film layer and at least one second film layer, the at least one second film layer and the at least one first film layer alternate together, a material of the at least one first film layer is one of SiₓO_{y} or TiₘOₙ, a material of the at least one second film layer is one of SiₓO_{y} or TiₘOₙ, wherein the m and the n are both greater than 0 and positive integers, a material of the at least one second film layer is different from a material of the at least one first film layer.

12. The optical lens of claim 9, wherein a thickness of the at least one light-absorbing film layer is defined as H₁, 450 nm≤H₁≤550 nm; and a thickness of the at least one anti-reflection film layer is defined as H₂, 50 nm≤H₂≤100 nm, or 300 nm≤H₂≤400 nm.

13. The optical lens of claim 12, wherein when H₁=525 nm and H₂=70 nm, the luminousness of the optical film is less than 7% and the reflectivity of the optical film is less than or equal to 5% in a visible light wavelength range of 400 nm to 700 nm.

14. The optical lens of claim 12, wherein when H₁=525 nm and H₂=360 nm, the luminousness of the optical film is less than 5% and the reflectivity of the optical film is less than or equal to 2% in a visible light wavelength range of 400 nm to 700 nm.

15. The optical lens of claim 12, wherein when H₁=525 nm and H₂=340 nm, the luminousness of the optical film is less than 4% and the reflectivity of the optical film is less than or equal to 1.7% in a visible light wavelength range of 400 nm to 700 nm.

16. A lens module, comprising:
a shot, wherein the shot comprises:
a lens, wherein the lens comprises a central area and a peripheral area surrounding the central area; and
an optical film formed on at least one surface of the lens, wherein the optical film comprises:
at least one light-absorbing film layer, and
at least one anti-reflection film layer formed on the at least one light-absorbing film layer; a material of the at least one light-absorbing film layer is powders of chromium metal and SiₓO_{y} mixed together, the x and the y are both greater than 0 and positive integers.

17. The lens module of claim 16, wherein in the at least one light-absorbing film layer, a range of an atomic weight content percentage of the chromium metal powder is from 0% to 30%.

18. The lens module of claim 16, wherein the at least one anti-reflection film layer comprises at least one first film layer and at least one second film layer, the at least one second film layer and the at least one first film layer alternate together, a material of the at least one first film layer is one of SiₓO_{y} or TiₘOₙ, a material of the at least one second film layer is one of SiₓO_{y} or TiₘOₙ, wherein the m and the n are both greater than 0 and positive integers, a material of the at least one second film layer is different from a material of the at least one first film layer.

19. The lens module of claim 16, wherein a thickness of the at least one light-absorbing film layer is defined as H₁, 450 nm≤H₁≤550 nm; and a thickness of the at least one anti-reflection film layer is defined as H₂, 50 nm≤H₂≤100 nm, or 300 nm≤H₂≤400 nm.

20. The lens module of claim 19, wherein when H₁=525 nm and H₂=70 nm, the luminousness of the optical film is less than 7% and the reflectivity of the optical film is less than or equal to 5% in a visible light wavelength range of 400 nm to 700 nm; when H₁=525 nm and H₂=360 nm, the luminousness of the optical film is less than 5% and the reflectivity of the optical film is less than or equal to 2% in the visible light wavelength range of 400 nm to 700 nm; and when H₁=525 nm and H₂=340 nm, the luminousness of the optical film is less than 4% and the reflectivity of the optical film is less than or equal to 1.7% in the visible light wavelength range of 400 nm to 700 nm.
